(19) United States
(12) Patent Application Publication
(10) Pub. No.: US 2012/0324418 A1
(43) Pub. Date: Dec. 20, 2012

(54) Software Application Framework Using Microsoft SharePoint

(76) Inventor: Chad Gerid Fallon, San Jose, CA (US)

(21) Appl. No.: 13/164,528

(22) Filed: Jun. 20, 2011

(51) Int. Cl. G06F 9/44

(52) U.S. Cl. 717/101

(57) ABSTRACT

A software invention that utilizes Microsoft's SharePoint as a foundation upon which a web based software application framework is built that can be used as a tool to quickly and easily create unique user applications with reduced programming effort via web service consolidation. The framework is made up of software layers that provide a fast, easy and efficient platform to build and execute complete web applications and to improve the use of and add new functions to SharePoint itself. The framework provides methods to be used with Microsoft development tools like Visual Studio. The data interface layer (consists of SharePoint Lists, Libraries, Tasks, Contacts, etc. with links and metadata) and is used as the data repository (database) for the framework resulting in a unique database layer in which SharePoint can be used to view and modify user application data making it uniquely simplified and easier to access than normal application database technology like transact SQL.

### FIELD OF INVENTION AND FIGURE DESCRIPTION

The invention is a Software Application Framework that provides a tool to quickly and easily develop web based software applications with reduced programming effort using Microsoft's SharePoint product (denoted as SharePoint) as a foundation. SharePoint is a Microsoft technology that allows a company to host intranet based web pages. It also enables the sharing of MS Office documents between users on the intranet. Often used to facilitate collaboration, provide content management features, implement business processes, and supply access to essential information. It allows groups to set up a centralized, password protected space for document sharing. Documents can be stored, downloaded and edited, then uploaded for continued sharing. The invention has three major parts 1) the development of the web application using an Integrated Development Environment (IDE), 2) the runtime operation environment when the developed application is used and 3) the database (data layer) for the application developed with this tool uses the SharePoint data structures (lists, libraries, groups, privileges, tasks, etc.) giving it an easy to view and modify database without having to know complicated database logic like transact SQL. This gives the user better control of his data.

The basic premise of this invention is to utilize the SharePoint infrastructure to create a software development tool that combines complicated interface functions into quickly and easily built web based software applications with reduced programming effort that can include the use of Microsoft's “Window's” and “Web” Forms for the application's user interface. In addition it provides a runtime package that the developed software application uses at execution time for processing. These runtime functions provide the necessary logic to implement the simple programming functions of the invention. This invention leverages and combines SharePoint's infrastructure to build its framework thereby allowing for rapid software development not possible when creating similar software applications with other development tools, like off-the-shelf Microsoft Visual Studio. The invention provides several software layers with classes and methods for rapid software development and deployment. These methods interface to SharePoint that provides low level features that are built into the invention. The SharePoint default Web Services are used within the software application framework in composite manner to reduce and simplify the programming effort and these include (but are not limited to):
WebSvcAdmin: Provides methods for managing a deployment of SharePoint Foundation, such as for creating or deleting sites.
WebSvcAlerts: Provides methods for working with alerts for list items in a SharePoint Foundation site.
WebSvcAuthentication: Provides classes for logging on to a SharePoint Foundation site that is using forms-based authentication.
WebSvcCellStorage: Enables client computers to synchronize changes made to shared files that are stored on a server.
WebSvcCopy: Provides methods for copying items between locations in SharePoint Foundation.
WebSvcdiagnostics: Enables client computers to submit diagnostic reports that describe application errors that occur on the client.
WebSvcDspSts: Provides a method for performing queries against lists in SharePoint Foundation.
WebSvcDWS: Provides methods for managing Document Workspace sites and the data they contain.
WebSvcForms: Provides methods for returning forms used in the user interface when working with the contents of a list.
WebSvcImaging: Provides methods that enable you to create and manage picture libraries.
WebSvcLists: Provides methods for working with lists and list data.
WebSvcMeetings: Provides methods that enable you to create and manage Meeting Workspace sites.
WebSvcPeople: Provides methods for working with security groups.
WebSvcPermissions: Provides methods for working with the permissions for a site or list.
WebSvcSharedAccess: Provides a method that determines whether a document is being coauthored.
WebSvcsharepointemailws: Provides methods for remotely managing distribution groups.
WebSvcSiteData: Provides methods that return metadata or list data from sites or lists in SharePoint Foundation.
WebSvcsites: Provides methods for working with Web sites.
WebSvcspsearch: Provides methods for remotely performing searches within a SharePoint Foundation deployment.
WebSvcUserGroup: Provides methods for working with users and groups.
WebSvcVersions: Provides methods for managing file versions.

WebSvcviews: Provides methods for working with list views.
WebSvcwebpartpages: Provides methods to send and retrieve Web Part information to and from Web services,
WebSvcWebs: Provides methods for working with Web sites and content types.
   In addition the SharePoint data can reside anywhere in a network, including the Internet, and the developed software application can reach and easily use this data as needed for processing. This also provides a data viewable interface (SharePoint web page features) to customize data views and to allow easy access to the relevant application data. Thus the user's application data is easily viewed and understood.

The invention can also be used to add unique SharePoint improvement features on top of SharePoint that is not possible with the actual SharePoint product. The invention's interface has many unique SharePoint functions that can be quickly programmed to do unique things with a user's SharePoint intranet sites. Using the SharePoint web services as part of the framework allows the software application to program a wide variety of unique and new SharePoint functions.

Appendix A provides a snapshot of a sample application.

FIG. 1 shows the base runtime architecture for the invention identifying the major software development layers as a runtime picture. These layers present a set of software base classes and methods that programmers can use to quickly build their web software application. The application under development 100 uses the framework layers 101, 102, and 103 to build upon and this takes place using a development tool like Microsoft Visual Studio as a separate non-runtime task. Once built and ready to use the runtime diagram is accurate. The details of the invention's layers are described in other figures. The runtime layers themselves are provided as part of the invention in Microsoft Dynamic Link Libraries (DLL) and the software application 100 makes runtime calls to the appropriate methods in the various invention layers. The DLL interface is used at development time to identify the methods that the software developer wants to use in building the software application 100. At runtime the layers through its methods make web services calls across a network 104 to SharePoint 105 to provide the required application functionality.

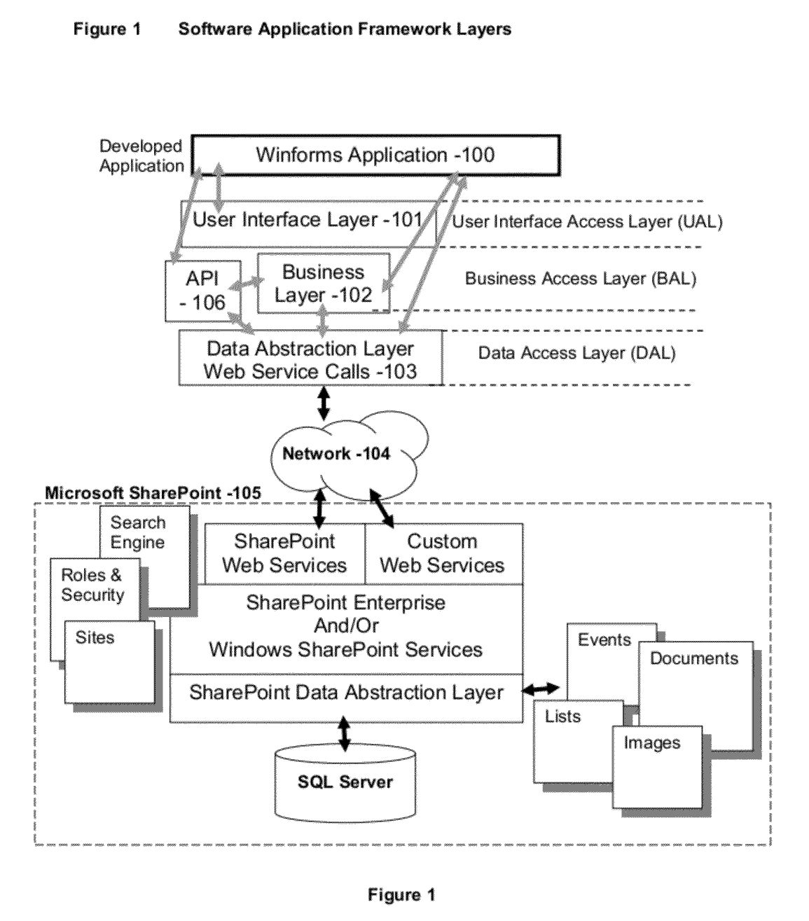

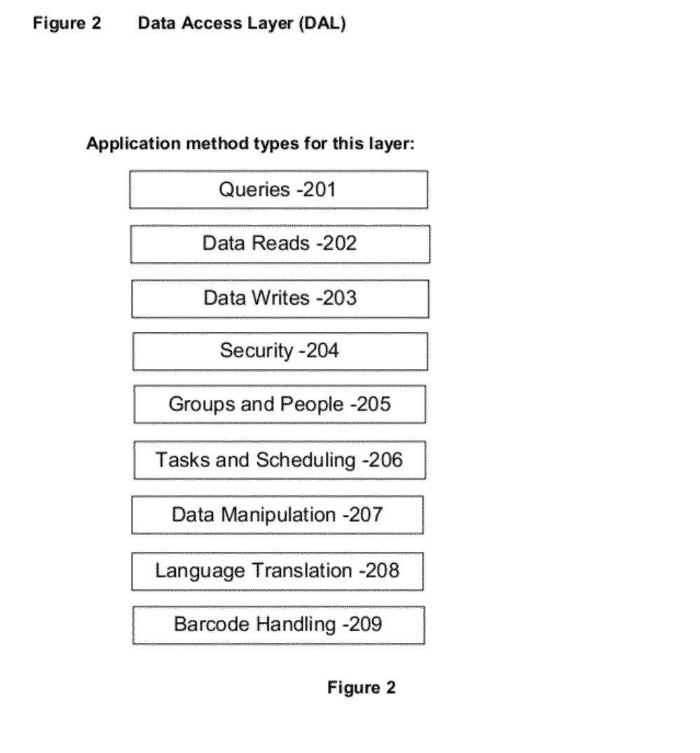

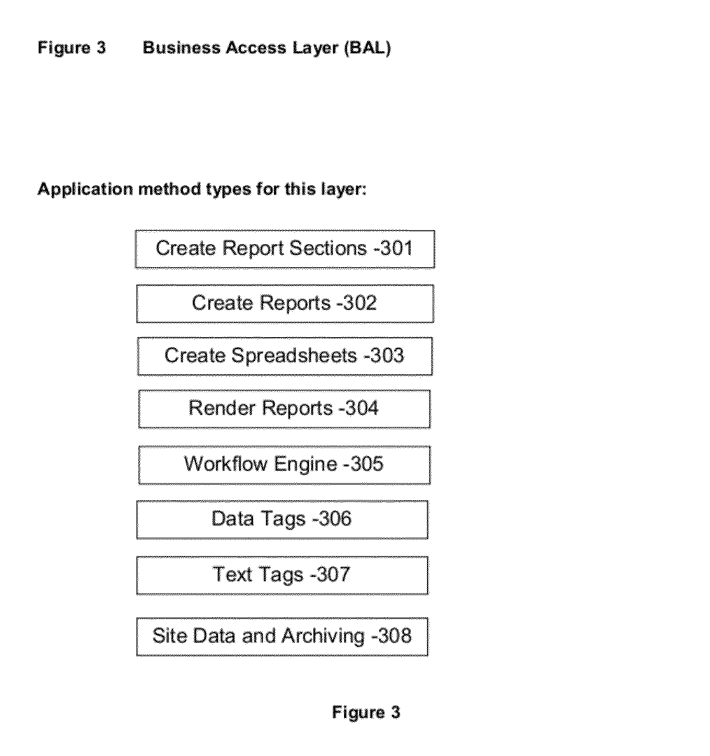

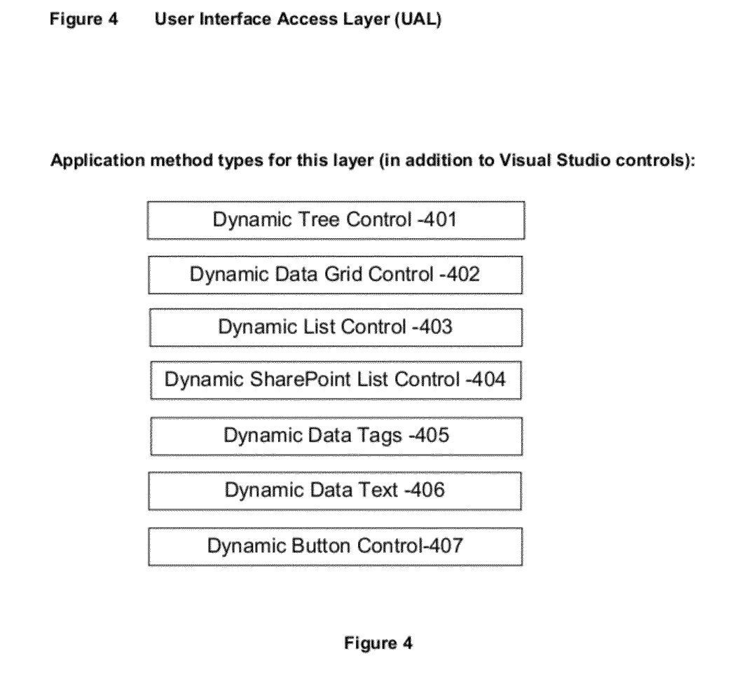

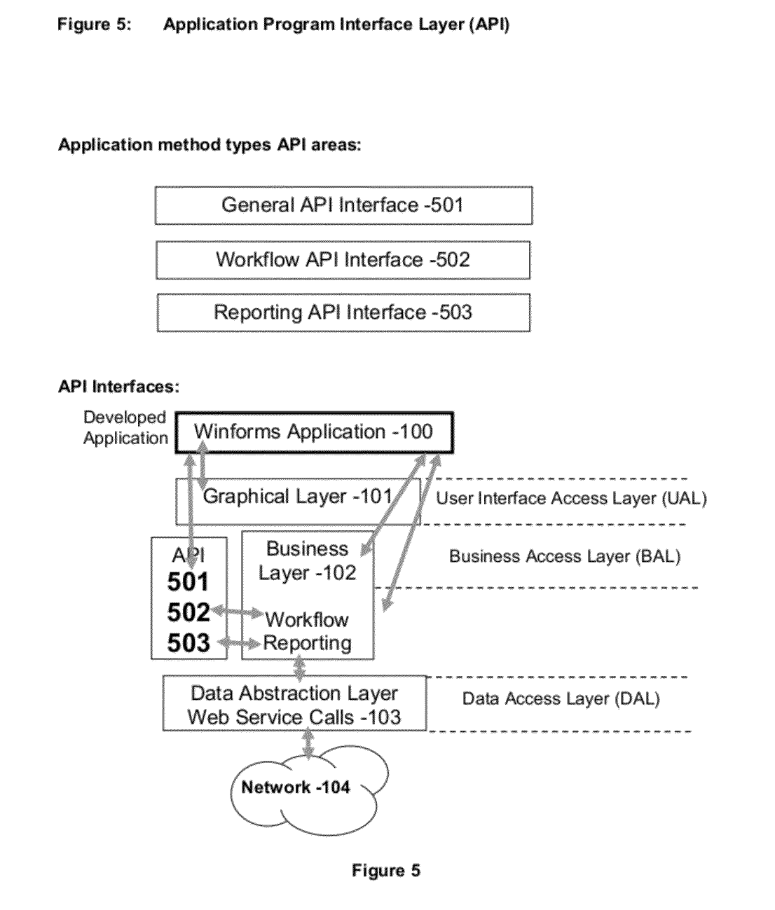

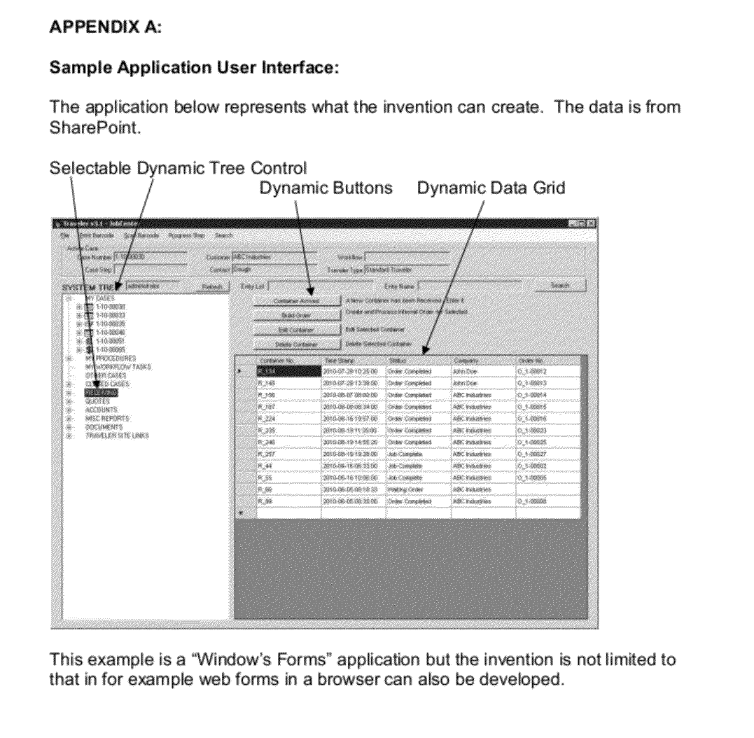

FIG. 2 shows the various components that combine complicated SharePoint web service usage into simple programming functions of the Data Access Layer 103 in FIG. 1. The access layer is an invention runtime layer and the invention also provides the development functions that allow building of the software application that uses the layer. These components are as follows:
201—Queries: Provides simplified database query methods to allow the software application to query data in the SharePoint data and receive the requested data information with reduced programming effort.
202—Data Reads: Provides simplified database data read methods to allow the software application to read specific data in the SharePoint data and receive the requested data information with reduced programming effort.
203—Data Writes: Provides simplified database data write methods to allow the software application to write specific data to the SharePoint data and update the data information with reduced programming effort.
204—Security: Provides checks for user privileges to restrict access to data and software application features with reduced programming effort. The SharePoint security features are used.
205—Groups and People: Provides methods so uses can utilize SharePoint people and groups within the software application with reduced programming effort. This can be used with security privileges to do group security.
206—Tasks and Scheduling: Provides methods for adding, updating and tracking tasks using SharePoint tasks with reduced programming effort.
207—Data Manipulation: Provides methods for adding, updating and deleting SharePoint data structures to include lists, libraries, contacts, tasks, etc. The software application database can be created and modified as needed with reduced programming effort. The SharePoint data structures are used as the database for the application and these methods interfaces to the structures.
208—Language Translation: Methods are provided to allow the software application being developed to easily support other languages. The application user screens can be set up and with these methods can dynamically support other languages.
209—Barcode handling: Methods are provided to allow the software application to support barcodes. It provides barcode reading and writing functions.

FIG. 3 shows the components that combine reporting and business logic into simple programming functions of the Business Access Layer 102 in FIG. 1. The access layer is an invention runtime layer and the invention also provides the development functions that allow building of the software application that uses the layer. These components are as follows:
301—Create Report Sections: Provides methods for creating report sections within SharePoint lists. The BAL provides a reporting solution that allows developers to dynamically create and render reports that can place discrete data, spreadsheets, tables, etc. into a report or document with reduced programming effort.
302—Create Reports: Provides methods for creating the report itself by putting together report sections and other data with reduced programming effort.
303—Create Spreadsheets: Provides methods for creating Microsoft Excel spreadsheets in SharePoint which can be included within a report when rendered with reduced programming effort.
304—Render Reports: Provides methods to render reports. Reports can be rendered into HTML, Microsoft Word or PDF formats. Initially the methods use specified style sheet transforms to build HTML which can then be rendered into Word or PDF formats.
305—Workflow Engine: The invention has its own workflow engine that is rules based. It provides features that are not provided in the SharePoint workflow feature. In addition all workflow steps provide hooks for developers to add Application Program Interface (API) calls for any special processing.
306—Data Tags: The invention defines “Data Tags” as a means of identifying where in a report or document that information is retrieved from the database and dynamically placed in the document at rendering time. The invention provides a window at development time to place data tags.
307—Text Tags: The invention defines “Text Tags” as a means of identifying where in a report or document that a report section is retrieved based on logical tests from the database and dynamically placed in the document at rendering time. This provides a way for a report or document to dynamically create the proper text section into a report at rendering time. The invention provides a window at development time to place text tags.
308—Site Data and Archiving: The invention provides methods for moving data and its associated links between SharePoint sites. This is especially useful for archiving data.

FIG. 4 shows the components of the User Interface Access Layer 101 in FIG. 1. This layer provides development and runtime functions for software applications to quickly add user interface forms and controls to the application. These components are as follows:
401—Dynamic Tree Control: Provides methods to quickly build a tree control which in turn can be used to invoke software application features.
402—Dynamic Data Grid Control: Provides methods to quickly build a data grid control which in turn can be used to invoke software application features.
403—Dynamic List Control: Provides methods to quickly build a list control which in turn can be used to invoke software application features.
404—Dynamic SharePoint List Edit Control: Provides methods to display and edit SharePoint list data. This component provides features not present in the default SharePoint list edit control.
405—Dynamic Data Tags: Provides methods to quickly add the appropriate data tag to a document or report.
406—Dynamic Text Tags: Provides methods to quickly add the appropriate text tag to a document or report.
407—Dynamic Button Control: Provides methods to quickly add a button and associate it with specific software application code.

FIG. 5 shows the Application Program Interface (API) 106 in FIG. 1. This layer provides a separate Microsoft Dynamic Link Library (DLL) for special processing functions that developer's can build and use to extend the software application. Such things a special report formatting, field formatting, special calculations, special processing functions, etc. Unlike all the other layers the API software layer can be modified by developers. The API components are as follows:
501—General API Interface: Provides a means to place calls to the API layer from anywhere in the application software.
502—Workflow API Interface: Provides a means to place calls to the API layer from the beginning or end of any workflow step. The developer can add the required processing in the API layer.
503—Reporting API Interface: Provides a means to place calls to the API layer from anywhere in the application software for specific report/document formatting, ordering, etc.

### DESCRIPTION OF PRIOR ART

Prior Art includes patents that address similar software application framework development. This patent application is based on a unique concept of using SharePoint as a foundation to bring about a unique new way to quickly and easily build web based software applications with reduced programming effort. In addition the invention provides a simple database support that is easier to view and modify than conventional databases. The following patents somewhat apply:
1. Application-centric user interface techniques—U.S. Pat. No. 7,846,023
2. Method Enterprise-scale application development framework utilizing code generation—U.S. Pat. No. 7,917,890
3. Structural editing operations for network forms—U.S. Pat. No. 7,937,651
4. Web Techniques for developing portal snippets using an integrated development environment (IDE)—U.S. Pat. No. 7,716,640
5. User interface for integrated spreadsheets and word processing tables—U.S. Pat. No. 7,673,227
6. Web-based visual development environment—U.S. Pat. No. 7,496,053
1. Application-centric user interface techniques—U.S. Pat. No. 7,846,023

### Abstract

Various application-centric user interface techniques are described. A user can easily launch, add, or update applications. An application-centric activity center can be presented as part of a user interface for an operating system shell. A file defining metadata for an application can be defined. The techniques can be applied to game-related software.
2. Method Enterprise-scale application development framework utilizing code generation—U.S. Pat. No. 7,917,890

### Abstract

A method, computer program product, and data processing system for managing and automating the development of large-scale software systems are disclosed. A preferred embodiment allows for the creation of a metamodel defining the functionality and structure of a software system. The metamodel may be defined according to input from developers or analysts. Additionally, database schemata, web services definitions, and other pertinent legacy metadata may be automatically imported into the metamodel to facilitate compatibility and/or functional comparability with legacy software systems. Specifications contained within the metamodel are then mapped to one or more code generation strategies. The code generation strategies identify and/or define patterns for the generation of source code that implements the specifications and behavior in the metamodel. Source code is generated according to the code generation strategies, which may then be modified as needed by a human programmer, and compiled into one or more executable applications.
3. Structural editing operations for network forms—U.S. Pat. No. 7,937,651

### Abstract

Systems and/or methods that enable an operation associated with an altered structure of a data instance of a network form without first altering the structure of the data instance are described. These systems and/or methods, in one embodiment, enable an operation of a network form eventually requiring alteration of a structure of a data instance of the network form without first performing a roundtrip with the network form's network computer. In another embodiment, the systems and/or methods approximate a view and editing experience associated with a structural change to a data instance of a network form without structurally changing the data instance
4. Web Techniques for developing portal snippets using an integrated development environment (IDE)—U.S. Pat. No. 7,716,640

### Abstract

Techniques for developing applications for various frameworks. An IDE is provided comprising user-selectable options for building applications for a first framework and also for building applications for a portal based upon a second framework different from the first framework. The portal applications for the portal based upon the second framework may be developed using a language supported by the first framework. User-selectable options provided by the IDE also enable deployment of the portal applications to the portal. A single IDE can be used to develop applications for different frameworks. For example, Visual Studio .NET may be used to develop applications for the .NET framework and also to develop and deploy portal applications (e.g., portal snippets) for a portal based upon a Java-based framework such as J2EE. The portal snippets may be developed using a .NET language.
5. User interface for integrated spreadsheets and word processing tables—U.S. Pat. No. 7,673,227

### Abstract

An architecture integrates spreadsheet functionality into tables commonly used in word processing programs and HTML documents. The architecture presents a table user interface (UI) that resembles a table when not being edited and adds spreadsheet elements to the table when being edited. Underlying the table UI, the architecture separates data handling functions from presentation functions. The architecture includes a table appearance manager to manage how the table appears in a document including such characteristics as table resizing, selection, cut, copy, paste, split, merge, table formatting and so on. The architecture also has a spreadsheet functionality manager to manage the spreadsheet functions for the table, such as recalculation, formula handling, sorting, referencing, and the like. The bifurcated architecture supports cross-table referencing, reference editing, automatic universal recalculation throughout all tables in the document, and nested table structures in which one table is nested within a cell of another table.
6. Web-based visual development environment—U.S. Pat. No. 7,496,053

### Abstract

A system and method for the rapid and visual web-based development of web-based customer service applications which render rich graphical user interfaces emulating the controls common to traditional desktop applications is disclosed. The rich user interface applications are comprised of scripting languages built with standard browser-based protocols and thus do not require the installation of any additional client-side or proprietary software applications. Not only is the user able to work on a rich user interface web application, but this application then allows the user to create, or develop, another web-based rich-thin-client application using visual programming tools.

None of the patents above offer the solution presented in this invention and instead use conventional software development frameworks that do not leverage their invention to reduce programming effort, simplify database use and leverage SharePoint to enhance its feature layers.

### DETAILED DESCRIPTION

Embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured on in terms of the claims. The invention is a Software Application Framework that provides a tool to quickly and easily develop web software applications with reduced programming effort using Microsoft's SharePoint product (denoted as SharePoint) as a foundation. The invention has three major parts 1) the development of the web application using an Integrated Development Environment (IDE), 2) the runtime operation environment when the developed software application is used and 3) the database (data layer) for the application developed with this tool uses the SharePoint data structures (lists, libraries, groups, privileges, tasks, etc.) giving it an easy to view and modify database without having to know complicated database logic like transact SQL. This gives the user better control of his data. Each component is described in the following sections. In addition the use of Microsoft's SharePoint is presented as it applies to the invention. FIG. 1 shows the overall runtime architecture of the invention, FIG. 2 shows the Data Access Layer (DAL), FIG. 3 shows the Business Access Layer (BAL)), and FIG. 4 shows the User Interface Access Layer (UAL) and FIG. 5 illustrates how the invention provides an Application Program Interface (API).

Data Access Layer (DAL):

The invention uses several methods to allow software application access to the SharePoint data as its database. See FIG. 2 for the DAL components. All access to SharePoint services are through this layer no other layer directly interfaces to SharePoint. This layer established the initial connectivity and authorization when the application comes up. It starts with a SharePoint logon and once logged on the user is restricted to access rights assigned by SharePoint. The system accepts the same logon Id and password as defined in SharePoint to validate the connection. Once connected the application methods then become available to the runtime software. All access is restricted via SharePoint privileges.

Accepting Business Access layer (BAL):

This layer provides special business type methods to allow software applications to quickly develop its required functions. See FIG. 3 for the BAL components. The methods augment features in SharePoint and allow for improved document creating, document handling, document rendering, spreadsheet creation, spreadsheet handling, formatted data, archiving, workflow, etc.

User Interface Layer (UAL):

This layer provides special user interface type methods to allow software applications to quickly develop its required functions. See FIG. 3 for the UAL components. The methods augment features in SharePoint and allow for improved user interface development. It especially focuses on the ability to create user interface controls dynamically at runtime.

Application Program Interface (API):

FIG. 5 illustrates the API interfaces supported. The main purpose of the API is to allow uses to customize and extend the capabilities of the invention. Thus developers can not only quickly build web software applications but can add custom features that I specific to their needs and also improves their development times.

Use of Microsoft Visual Studio at Development Time

Before a software application can be used it must be developed. The invention can use Microsoft's Visual Studio but other Integrated Development Environments (IDE) can be used. The interface specification of the invention's software layers is used to provide the special methods that make software development quick and easy. Visual Studio can be used with the invention to build the software applications and once built it can be deployed and then the invention operates in its runtime environment (see FIG. 1).

What is claimed is:

1. The invention will be a web software application development tool that quickly and easily builds web based software applications with reduced programming effort using Microsoft SharePoint web services in a consolidated manner and interfacing with SharePoint features as its underpinnings whereas;
The invention, by default, will provide a set of software layers, classes and methods that can be used in Microsoft Visual Studio (or other tool) to create the application software and;
Software layers are implemented consolidating SharePoint web services to make the development structured, quick and easy and;
Uses SharePoint web services to automatically enable application features to include but not limit to data access, scheduling, security, privileges and workflow

2. The invention also provides a means to develop special SharePoint features with reduced programming effort that are not available in SharePoint itself whereas;
The invention can develop features to easily format and display SharePoint Lists and Libraries using “Windows Forms” offering many additional controls and;
The invention can provide a level of programming with web services consolidation not available using SharePoint custom web services and;
The invention can provide a user interface based on either Microsoft windows or web forms making it much more robust.

3. The invention's software application data layer (database) uses the SharePoint data controls (lists, libraries, contacts, etc.) as the actual application data whereas;
The invention creates the database links and keys using standard SharePoint metadata links in lists, libraries, tasks and contacts and;
The invention brings the data layer (database) to SharePoint's data viewing interface making the data much easier to use and more accessible to anyone using the developed software applications and;
Makes the data easily viewed and the views of the data can be customized using standard SharePoint features and;
Makes the data more easily modified using standard SharePoint features and;
Makes the access to the data more secure using standard SharePoint groups, security and privileges and;
Simplifies user data access such that it is used as the data repository (database) for the software application framework resulting in a unique database layer in which SharePoint can be used to view and modify user application data making it uniquely simplified and easier to access than normal application database technology like transact SQL.
